(19) United States
(12) Patent Application Publication
(10) Pub. No.: US 2010/0065400 A1
(43) Pub. Date: Mar. 18, 2010

(54) BALL TRANSFER DEVICE

(76) Inventors: David Pruett, Canon City, CO (US); Raymond Middlemiss, Canon City, CO (US); Thomas Harding, Canon City, CO (US)

Correspondence Address: KLAAS, LAW, O''MEARA & MALKIN, P.C., 1999 BROADWAY, SUITE 2225, DENVER, CO, 80202, US

(21) Appl. No.: 12/555,489

(22) Filed: Sep. 8, 2009

Related U.S. Application Data
(60) Provisional application No. 61/095,555, filed on Sep. 9, 2008.

(51) Int. Cl. B65G 39/02; F16C 29/04; B65G 13/00

(52) U.S. Cl. 193/35 MD; 384/49

(57) ABSTRACT

A ball transfer device is disclosed herein. An embodiment of the ball transfer device includes a chamber, a first ball, and a second ball. A first opening and a second opening extend into the chamber. A cavity extends from the chamber and has a cavity opening connected to the second opening. The first ball is movable within the chamber between a first position and a second position, wherein a portion of the first ball is movable into the first opening when the first ball is in the first position, and wherein the first ball is located between the first opening and the second opening. The second ball is located in the cavity, wherein the second ball is movable within the cavity between a first position and a second position, wherein a portion of the second ball is movable into the chamber when the second ball is in the first position, and wherein the first ball is located between the cavity and the cavity opening. The second ball is contactable with the first ball when the second ball is in the first position.

This application is a continuation of patent application Ser. No. 61/095,555, filed on Sep. 9, 2008 for BALL TRANSFER DEVICE. This application claims the benefits of the prior application, which is incorporated by reference for all that is disclosed therein.

### BACKGROUND

Conveyor systems are used to transport items between different locations. Items may be goods produced by factories or articles transported within factories, distribution centers, airports, and other facilities. Uses of conveyor systems include factories and distribution centers. Factories that produce large quantities of goods typically have to move the goods at a high rate of speed in order to be efficient. Likewise, distribution centers are typically required to move goods quickly in order to be efficient.

The speed of belt-type conveyor systems is limited. When the belts reach a high speed, they tend to become unstable, which may cause them to fail. The failure will stop the conveyor system and may damage the items and injure persons proximate the conveyor system.

### BRIEF DESCRIPTION OF THE DRAWINGS

FIG. 1 is a top perspective view embodiment of a conveyor system.

FIG. 2 is an elevational partial cross-sectional view of a ball unit of the ball transfer device of FIG. 1.

FIG. 3 is a top plan view of a cup portion of the ball unit of FIG. 2.

FIG. 4 is an elevational view of the cup portion of FIG. 3.

FIG. 5 is a top plan view of a cap portion of the ball unit of FIG. 2.

FIG. 6 is an elevational view of the cap portion of FIG. 5.

FIG. 7 is an elevational view of the first bearing of FIG. 7.

FIG. 8 is an elevational view of the second bearing of FIG. 2.

FIG. 9 is a bottom view of the second bearing of FIG. 8.

FIG. 10 is a cross sectional view of the platform of FIG. 1 with the corresponding ball unit removed for illustrative clarity.

FIG. 11 is another embodiment of the cross sectional view of the platform of FIG. 1.

### DETAILED DESCRIPTION

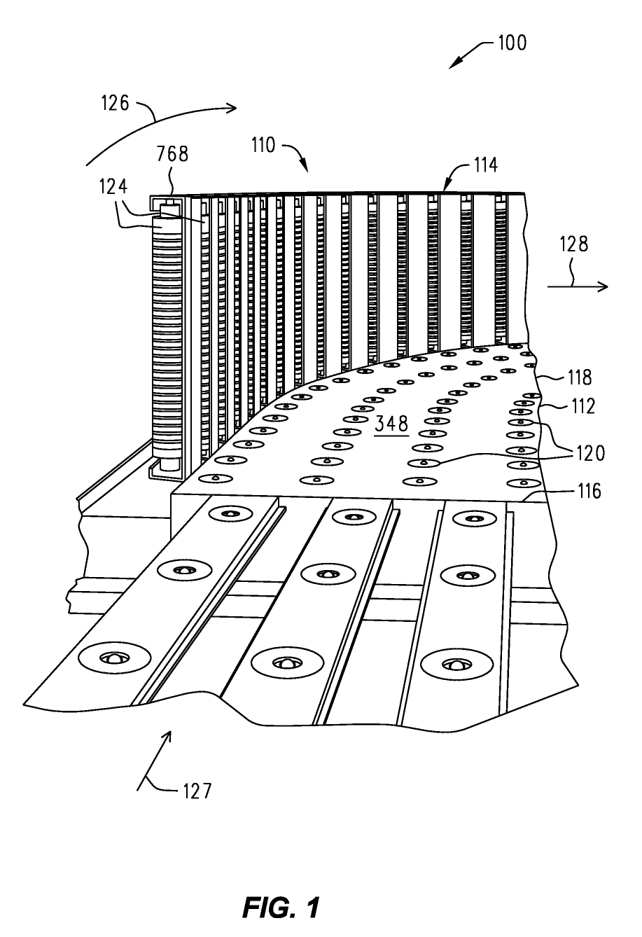

A top perspective view of a conveyor system 100 is shown in FIG. 1. The conveyor system 100 includes several components that are described in greater detail below. The conveyor system includes a curved portion 110 that includes a platform 112 and a wall 114. The curved portion includes a first end 116 and a second end 118 wherein items travel from the first end 116 to the second end 118. As described in greater detail, the platform 112 includes a plurality of ball transfer units 120 that facilitate the movement of items.

A plurality of embodiments of the wall 114 are described herein. The wall facilitates changing the direction of items moving along the conveyor system 100. More specifically, the items move along the curve of the wall 114 and may do so without significantly reducing their velocities. The curve of the wall 114 is referred to as an arcuate path 126. The arcuate path 126 causes items to change directions from a first linear direction 127 to a second linear direction 128. The devices associated with the wall 114 may also increase or decrease the velocities of the items as required by a user. In the embodiment of the conveyor system 100 of FIG. 1, the devices are air-cooled pulleys 124. In other embodiments, the devices are ball transfer units located along or within the wall 114.

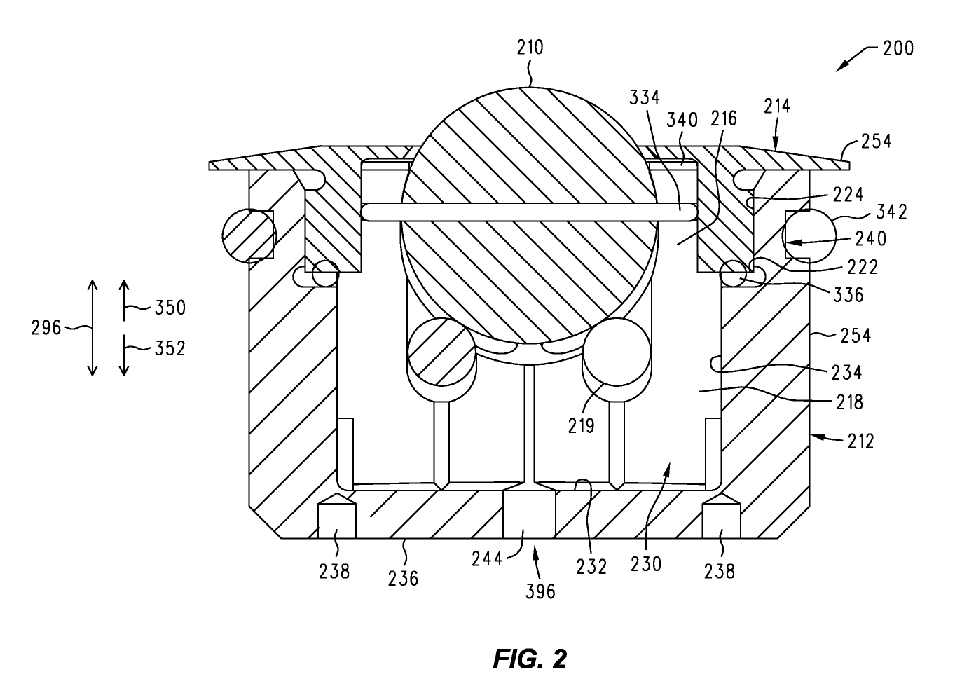

The description of the conveyor system 100 will begin with the ball transfer units 120, which may be used on the platform 112 and on the wall 114. An embodiment of a ball transfer unit 200 is shown in greater detail in FIG. 2. The ball transfer unit 200 is an example of the plurality of ball transfer units 120 of FIG. 1. The ball transfer unit 200 may include a first ball or sphere, such as the first ball 210 shown in conjunction with the ball unit 200. The a first ball 210 of the ball transfer unit 200 is able to rotate in any direction relative the ball transfer unit 200 in a manner that will be described in further detail herein. Accordingly, a plurality of ball transfer units 120, FIG. 1, are able to support the weight of an item being conveyed and yet allow the item to move in any direction.

As can be appreciated from the above description, and with reference again to FIG. 1, the plurality of ball transfer units 120 allow an item, such as a tote, being conveyed thereon to move in the direction of the arcuate path 126 of the wall 114 while being fully supported. The wall 114 of the curved portion 110 forces the items to follow the arcuate path 126 and thus change from the first linear direction 127 to the second linear direction 128. It is noted that the ball transfer units 120 are shown in a generally round configuration herein for exemplary illustrative purposes only. The ball transfer units 120 could alternatively be formed having virtually any shape, for example, a shape that is more closely chosen to fit the desired curve.

Referring again to FIG. 2, the ball transfer unit 200, which is sometimes simply referred to as the ball unit 200, may generally include a cup portion 212 and a cap or lid portion 214 threadingly attached to the cup portion 212. Other mechanisms, such as adhesives may also secure the cup portion 212 to the lid portion 214. A pair of bearings 216, 218 may be housed within cup portion 212 as shown and the first ball 210 may be moveably received relative to the bearings 216, 218. In some embodiments, the bearings 216, 218 may be a configured different, but serve the same purposes as those described herein. The bearings 216, 218 are described in greater detail below. A second ball 219 is received in the second bearing 218 and serves to facilitate the movement of the first ball 210. It is noted that the ball unit 200 may have a plurality of second balls located therein, which all may function the same as or substantially similar to the second ball 219 described herein.

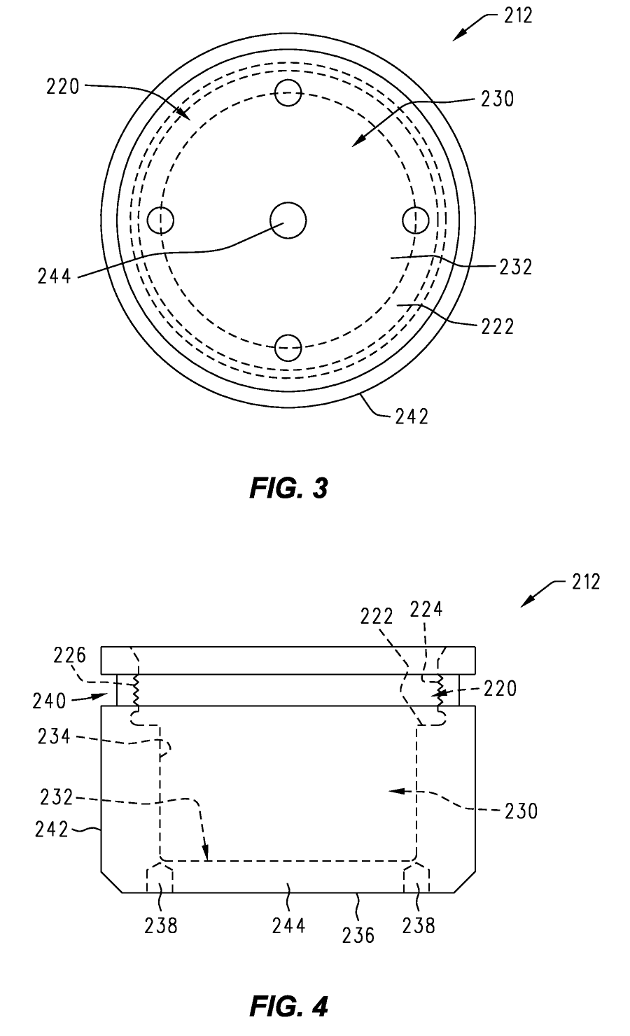

FIGS. 3 and 4 illustrate the cup portion 212 in further detail. With reference to FIGS. 3 and 4, cup portion 212 may, for example, be integrally formed from a metal material, such as steel, stainless steel, or aluminum. The cup portion 212 may include a first chamber 220 having an annular bottom wall 222 and a circumferential sidewall 224 having threads 226 formed therein. As described in greater detail below, the threads 226 are used to secure the lid portion 214, FIG. 2, to the cup portion 212 within the chamber 220. A second chamber 230 may be concentrically located with respect to the first chamber 220, extending downwardly from the bottom wall 222 thereof. The second chamber 230 may include an annular bottom wall 232 and a circumferential sidewall 234 as shown. A hole, such as a threaded hole 244 may extend between the cup portion 212 bottom surface 236 and the bottom wall 232 of the second chamber 230.

Having described some of the interior components and elements of the cup portion 212, some of the exterior components and elements will now be described. A plurality of blind holes 238 may extend from the cup portion bottom surface 236 into the cup portion 212 to facilitate engagement with a wrench or other tool. Such tools may be used during manufacture or installation of the cup portion 212 or the ball unit 200 as a whole. An annular groove 240 may be formed in the outer circumferential surface 242 of the cup portion 212, as shown. As described in greater detail below, the groove 240 facilitates the attachment of the cup portion 212 to a surface or other structure.

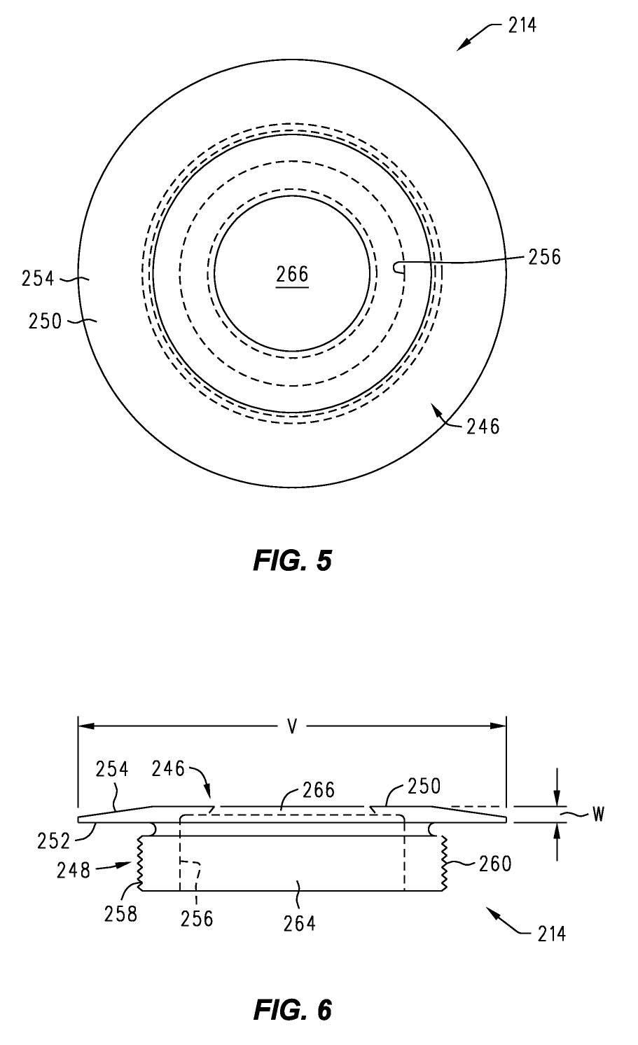

FIGS. 5 and 6 illustrate the cap portion 214 in further detail. The cap portion 214 may, for example, be integrally formed from plastic or other material, such as a metal. The cap portion 214 may generally include a flange portion 246 and an annular wall portion 248 extending downwardly therefrom. The flange portion 246 may include an upper surface 250 and an oppositely disposed lower surface 252 and may have a diameter “V”. The diameter “V” may, for example, be about 2.5 inches or about 6.35 centimeters. The flange portion 246 may have a thickness “W” extending between the upper surface 250 and lower surface 252. The thickness “W” may, for example, be about 0.094 inch or about 0.24 centimeters. The flange portion 246 may have a tapered portion 254. The tapered portion 254 facilitates the movement of items over the ball unit 200 when used in the conveyor 100, FIG. 1.

The annular wall portion 248 may include a circumferential inner surface 256 and an oppositely disposed circumferential outer surface 258. Threads 260 may be formed on the outer surface 258. The threads 260 are used to screw the cap portion 214 into the cup portion 212 as described below. As described above, other fastening mechanisms may be used to secure the cap portion 214 to the cup portion 212.

As can be appreciated with reference to FIG. 6, a chamber 264 is generally bounded by the lower surface 252 of the flange portion 246 and the inner surface 256 of the annular wall portion 248. An opening 266 is provided in the flange portion 246 extending between the flange portion upper surface 250 and lower surface 252. In some embodiments, the opening 266 is a concentric tapered opening 266. As described in greater deal below, the first ball 210, FIG. 2, may extend through the opening 266 when air pressure is applied to the ball unit 200, FIG. 2. In some embodiments, the first ball 210 always extends through the opening 266, but extends further when air is applied to the ball unit 200.

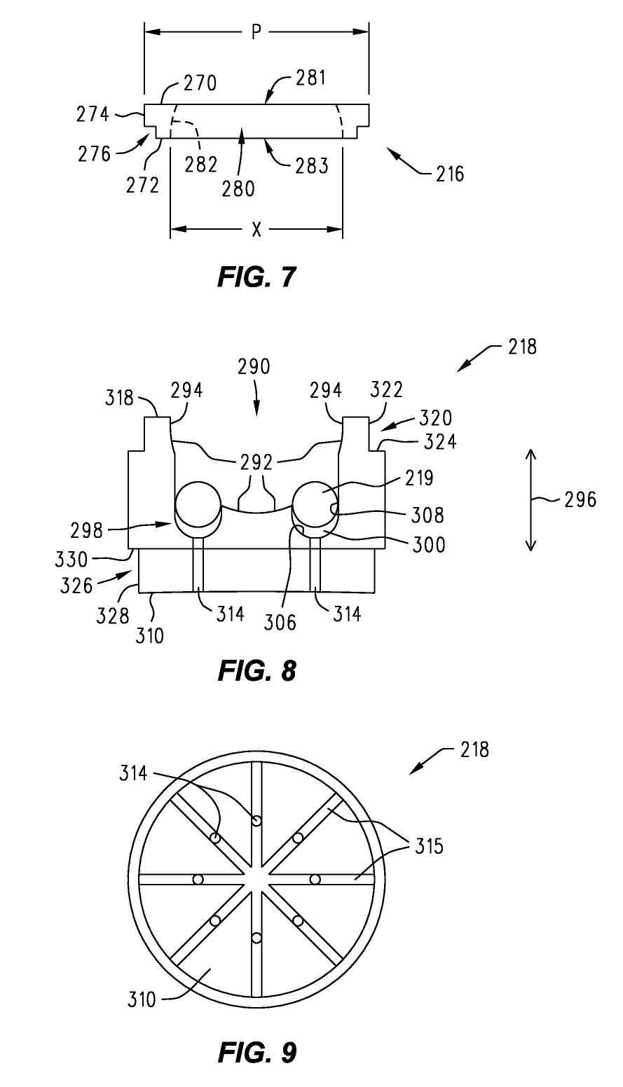

The first bearing 216, FIG. 2, will now be described. With additional reference to FIG. 7, which is a side cut away view of the first bearing 216, the first bearing 216 may be integrally formed, for example, from oil impregnated wood, such as maple. Although wood is currently preferred due, for example, to the ease with which it may be worked, an alternative material could be used so long as it possesses adequate friction properties as described herein. In some embodiments, the first bearing 216 is made from a polymer. The first bearing 216 may include a first annular end surface 270 and a second, oppositely disposed, annular end surface 272. The first bearing 216 may further include an outer circumferential surface 274 having a diameter “P” as indicated. The diameter “P” may, for example, be about 1.25 inches. A notch 276 may be located between the circumferential surface 274 and the annular end surface 272. The notch 276 serves to receive a gasket or other seal used to prevent fluid from passing between the bearings 216, 218, FIG. 2, as described in greater detail below.

A chamber 280 may be located within the first bearing 216, the chamber 280 being partially defined by a surface 282. The surface 282 is partially spherical so as to receive the first ball 210, FIG. 2. The widest diameter of the chamber 300 has a diameter “X”. The diameter “X” may be chosen to be only slightly larger than the diameter “Y” (FIG. 2) of the first ball 210 in order to reduce fluid loss from the system, as will be discussed further herein. The diameter “X” may, for example, be about 1.006 inches or about 2.56 centimeters while the diameter “Y” may, for example, be about 1.000 inch or about 2.54 centimeters. The chamber 280 has a first opening 281 and a second opening 283 through which the first ball 210, FIG. 2, may extend.

A side elevation view of an embodiment of the second bearing 218 is shown in FIG. 8. The second bearing has a chamber 290 that is configured to receive the first ball 210, FIG. 2. The diameter of the chamber 290 is sized so as to substantially form a seal when the first ball 210 is located therein. The chamber 290 may have two portions, a spherical portion 292, and a cylindrical portion 294. The spherical portion 292 is shaped to receive the first ball 210, FIG. 2, and may have a radius that is substantially the same as the first ball 210 in order to receive the first ball 210. In some embodiments, the spherical portion 292 is slightly larger than the radius of the first ball 210 in order to allow the first ball 210 to move therein. The cylindrical portion 294 may have a diameter that is slightly larger than the diameter of the first ball 210 in order to allow the first ball 210 to move in the direction 296 while maintaining a fluid seal between the first ball 210 and the cylindrical portion 294. It is noted that the first ball 210 may only move as little as a tenth of an inch in the direction 296.

A plurality of cavities 298 may extend from the chamber 290. It is noted that in some embodiments, only one cavity extends from the chamber 290. A cavity 300 will be described herein. The cavity 300 is substantially similar or identical to all the cavities 298 formed in the second bearing 218. The cavity 300 is configured to receive the second ball 219 and to allow the second ball 219 to move in the direction 296. The cavity 300 has a substantially spherical bottom 306 and a substantially cylindrical side wall 308. The diameters of the bottom 306 and the side wall 308 are sized to receive the second ball 219 and to allow the second ball 219 to move in the direction 296 while maintaining a substantial seal between the second ball 219 and the cavity 300.

A bottom surface 310 is located opposite the chamber 290. The bottom surface 310 is configured to be located proximate the bottom wall 232, FIG. 2, of the second chamber 230 of the cup portion 212 when the second bearing 218 is located within the second chamber 230. Cavity opening 314 extend between the cavity 300 and the bottom surface 310. The openings 314 serve to pass a fluid between the bottom surface 310 of the cavity 310 and the chamber 290 in order to move the first ball 210 and the second ball 219 in the direction 296. The fluid may be air and may have a lubricant in it. It is noted that the openings 314 may extend to other areas of the second bearing 218 to allow fluid to enter from other regions of the second bearing 218.

The bottom surface 310 of the second bearing 218 is shown in FIG. 9. The bottom surface 310 has a plurality of channels 315 formed therein that enable fluid, such as air, to pass to the holes 314. The fluid is thereby distributed to all the cavities 300 equally. With additional reference to FIG. 2, the fluid may enter the channels 315 via the hole 244.

Returning to FIG. 8, the second bearing 218 has a top surface 318 that is located opposite the bottom surface 310. The top surface 318 serves as a mating surface between the first bearing 216, FIG. 2, and the second bearing 218. A first notch 320 is located opposite the cylindrical portion 294 of the chamber 290 and extends from the top surface 318. The first notch 320 includes a vertical wall 322 that meets a horizontal wall 324. The first notch 320 is configured to receive the cap portion 212 when the ball unit 200 is assembled. A second notch 326 extends from the bottom surface 310. The second notch has a vertical wall 328 extending from the bottom surface 310. A horizontal wall 330 extends from the vertical wall 328. The second notch 326 may serve to hold a seal to prevent fluid from leaking around the second bearing 218. In some embodiments, the second notch 326 may serve to enable better movement of the fluid so that it is distributed to all the channels 315. For example, if the fluid inlet is in the side of the cup portion 212, the second notch 326 enables better transfer of the fluid to the holes 314.

The second bearing 218, like the first bearing 216, may be made of oil impregnated wood or other low friction material. In some embodiments, the second bearing 218 is made of oil impregnated maple. In other embodiments, the second bearing 218 is made of a polymer.

### Assembly of the Ball Transfer Device

Having described the components of the ball unit 200, FIG. 2, the ball unit 200 as a whole will now be described. With additional reference to FIG. 2, the aforementioned components may be assembled as follows. The second bearing 218 may be installed within the second chamber 230 of the cup portion 212 such that the chamber 290 is facing upwardly, as shown. The bottom surface 310 is located proximate the bottom wall 232 of the second chamber 230.

The second ball 219 may then be placed into the cavity 300. It is noted that the second bearing 218 may have several cavities 298. In such embodiments, second balls 219 are placed in all the cavities 298. The first ball 210 may then be placed within the chamber 290 of the second bearing 218. An O-ring 336 or other gasket material may be placed on the top surface 318 of the second bearing 218. The O-ring 336 may be located proximate the vertical wall 322 of the second bearing 218. The O-ring 336 serves to form a seal between the first bearing 216 and the second bearing 218.

The first bearing 216 may then be installed over the first ball 210 in an orientation opposite to that of the second bearing 218 (i.e., the first bearing 216 is installed such that the chamber 280, FIG. 7 is facing downwardly. After installing the first bearing 216 in this manner, the annular end surface 272 of the first bearing 216 may be in substantial contact with the top surface 318 of the second bearing 218. The O-ring 290 will also be in the notch 276 of the first bearing 216.

An O-ring 336 or other gasket may be placed in the first chamber 220 of the cup portion 212. The O-ring 336 may set on the bottom wall 222 of the first chamber 220. A gasket 340 may be installed on the first annular end surface 270 the first bearing 216. The gasket 340 may serve to prevent contaminants from entering the chamber 280 or otherwise interfering with the rotation of the balls 210, 219. The gasket 340 may contact the first ball 210 and may extend into the opening 266 of the cap portion 214, FIG. 6.

The cap portion 214 may then be installed on the cup portion 212 by engaging the threads 260 of the cap portion 214, FIG. 6, with the threads 226 of the cup portion 212, FIG. 4. More specifically, the cap portion 214 may be screwed into the cup portion 212. When the cap portion 214 is screwed onto the cup portion 212, the O-ring 336 and the gasket 340 seat into place. An O-ring 342 may be fitted within the groove 240 of the cup portion 212, as illustrated in FIG. 2

With continued reference to FIG. 2, in operation, the balls 210, 219 are able to move in the direction 296. More specifically, the balls 210, 219 can move in an up direction 350 and a down direction 352, which places the balls in an up position and a down position, respectively. As can be appreciated, in the up position, the first ball 210 is in contact with the opening 281 of the first bearing 216. In the down position, the first ball 210 is in contact with the spherical portion 292 of the second bearing 218, FIG. 8. Alternatively, the first ball 210 may remain in contact with the second ball 219.

When the second ball 219 is in the up position, it may contact the first ball 210 and may exert additional force on the first ball 210 in the up direction 350. When the second ball 219 is in the down position, it contacts the bottom 306 of the cavity 300. In some embodiments, the first ball 210 may remain in contact with the second ball 219 when the second ball 219 is in the down position. Therefore, when the first ball 210 is in the down position, it may either contact the second balls 219 or the spherical portion 292 of the second bearing 218. In either embodiment, the first ball 210 is able to rotate and carry a load applied to the ball transfer device 200.

### Platform

The platform 112 of the conveyor system 100, FIG. 1, will now be described. It is noted that several different embodiments of the platform will be described including embodiments were the ball units 120 are recessed into the platform 112 and embodiments wherein the ball units 120 extend from the surface of the platform.

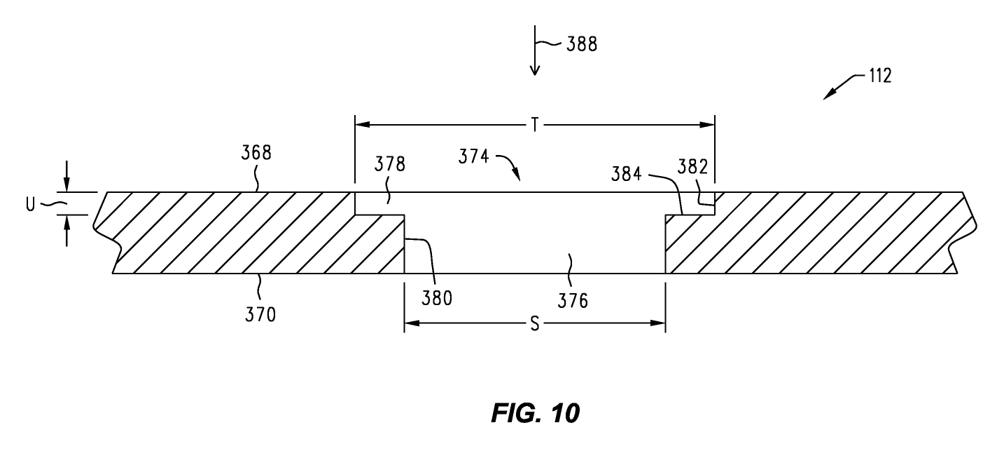

FIG. 10 is a cross-sectional view of a portion of the platform 112. As shown in FIG. 10, the platform has an upper surface 368 and a lower surface 370. With additional reference to FIG. 1, the platform 112 has a plurality of holes or openings that are sized to receive the ball units 120. An opening 374 is exemplary of the other openings in the platform 112. The opening 374 is shown with the corresponding ball unit removed for clarity. As can be seen from FIG. 10, the opening 374 may include a through hole 376 extending through the platform 112. The hole 376 includes a counterbored portion 378. The hole 376 may be defined by a circumferential surface 380 having a diameter “S” while the counterbored portion 378 may be defined by a circumferential surface 382 having a diameter “T” and by an annular lower surface 384. The annular lower surface 384 may be located a distance “U” from the upper surface 368 of the platform 112.

Referring additionally to the ball unit 200 of FIG. 2, the diameter “S” of the through hole 376 may be slightly larger than the diameter of the cup portion outer surface 254. Accordingly, when the cup portion 212 of the ball unit 200 is installed in the opening 374, the cup portion 212 will easily fit within the through hole 376 of the platform 112. The diameter “T” of the counterbored portion 378 may be slightly larger than the diameter “V” of the flange portion 246, FIG. 6. The diameter “V” facilitates the insertion of the ball unit 200 into the opening 374 as described in greater detail below.

To install the ball unit 200, FIG. 2, within the opening 374, the ball unit 200 may first be positioned over the opening 374 and then moved downwardly in the direction indicated by the arrow 388 in FIG. 9, causing the ball unit cup portion 212 to move through the through hole 376 of the opening 374. This downward movement is continued until the lower surface 252 of the ball unit cap portion 214, FIGS. 2 and 6, contacts the annular lower surface 384 of the counterbored portion 378. In this condition, the O-ring 342, FIG. 2, will be compressed between the outer surface 254 of the cup portion 212, FIGS. 3 and 5, and the circumferential surface 380 of the through hole 376, thus retaining the ball unit 200 within the opening 374. The O-ring 342 may also be compressed between the groove 240 between the outer surface 254 and the circumferential surface 380. Alternatively, the ball unit 200 may be retained within the opening 374 in any conventional manner.

Other embodiments of the installation include screwing or otherwise attaching the ball unit to the platform 112. In some embodiments, the cap portion 214 is integrally formed into the platform. The cup portion 212 may then be screwed or otherwise attached to the cap portion 214.

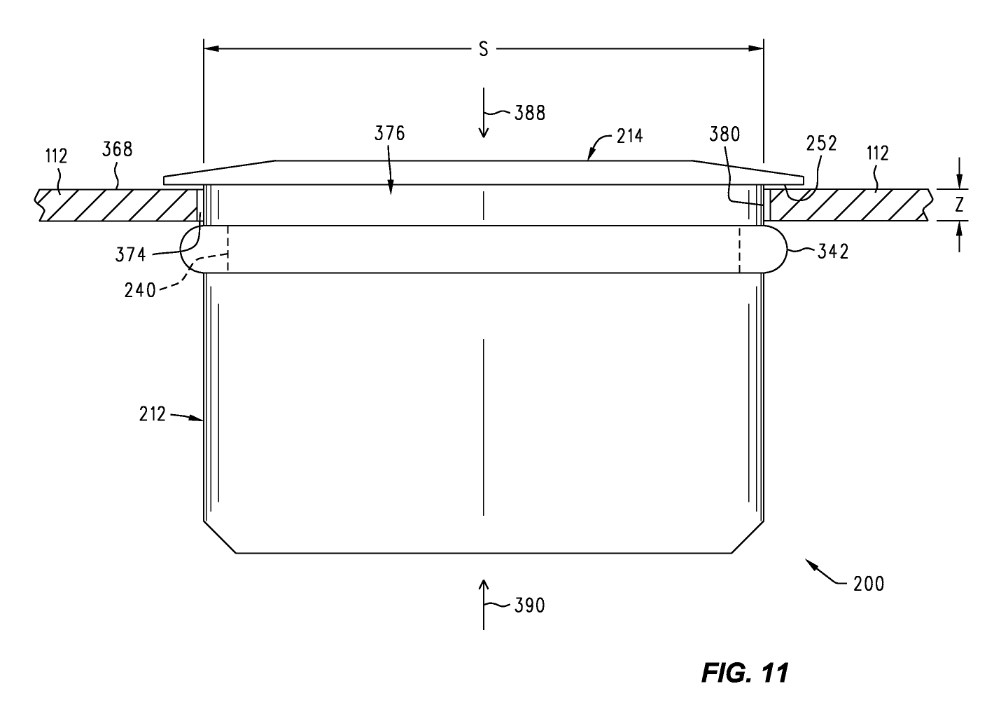

FIG. 11 shows an alternative arrangement for mounting the ball units 200 within the platform 112. In FIG. 11, the ball unit 200 is shown mounted within the opening 374 of the platform 112. For illustrative purposes, the platform 112 is shown in cross-section while the ball unit 200 is not. The remaining openings in the platform 112 may be formed in a substantially identical manner as will now be described.

As in FIG. 10, the through hole 376 in FIG. 11 may extend completely though the platform 112. In the FIG. 11 embodiment, however, the counterbored portion 378 shown in FIG. 9 may be omitted. With reference to FIG. 11, through hole 376 may be defined by a circumferential surface 380 having a diameter “S”. The diameter “S” of the through hole 376 may be slightly larger than the diameter of the cup member outer surface 254. The thickness “Z” of the platform 112 may be chosen to be the same as the distance between the O-ring 342 and the lower surface 252 of the cap portion 214. In some embodiments, the thickness “Z” may be slightly greater than the distance between the O-ring 342 and the lower surface 252 of the cap portion 214.

To install the ball unit 200 within the opening 374, the ball unit 200 may first be positioned over the opening 374 with the O-ring 342 removed. The ball unit 200 may then be moved downwardly in the direction indicated by the arrow 388 in FIG. 10, causing the ball unit cup portion 212 to move through the through hole 376 of the opening 374. This downward movement is continued until the lower surface 252 of the ball unit cap portion 214 contacts the upper surface 368 of the platform 112. In this condition, the annular groove 240 will be located just below the lower surface 370 of the platform 112. The O-ring 342 may then be installed within the groove 240 by sliding it over the cup portion 212 from beneath the platform 112 in the direction 390. Once the O-ring 342 is installed in this manner, it will prevent the ball unit 200 from moving in the direction 390, thus securely locking the ball unit 200 in place.

### Operation of the Ball Unit

The operation of the ball units 120, FIG. 1, in the conveyor system 100 will now be described. The ball units 120 will be described with reference to the ball unit 200, FIG. 2, As noted previously, the first ball 210, FIG. 2, is able to move between an up position and a down position. Thus, when the first ball 210 is in the up position, a relatively larger portion of the first ball 210 will extend above the upper surface 368 of the platform 112. When, however, the first ball 210 is in the down position, a relatively smaller portion of the first ball 210 will be located above the surface 348 of the platform 112. In some embodiments, the first ball 210 is located below the upper surface 250 of the ball unit cap portion 214 when the first ball 210 is in the down position.

A supply of compressed air, or other fluid, indicated schematically in FIG. 2 by the reference numeral 396, may be connected to the hole 244 in the cup portion 212 in a conventional manner. As can be appreciated, when no compressed air is supplied, the balls 210, 219, will, due to gravity, be located in the down position. When, however, compressed air of sufficient pressure is supplied, the balls 210, 219 will be forced to the up position. In this upper position, the ball 210 will effectively seal against the opening 281, FIG. 7, of the first bearing 216 and prevent substantial loss of compressed air from the system.

With additional reference to FIG. 8, when the compressed air 396 is supplied to the ball unit 200, the air causes the second ball 219 to move to the up position. The area of the cavity 300 causes the air to apply a force to the second ball 219 against the first ball 210. This extra force adds to the weight carrying capability of the first ball 210. In addition, with the extra force applied to the first ball 210 via the second ball 219, the second ball enables the first ball 210 to rotate as needed. The first ball 210 effectively rolls on the second ball 219.

It has been found that when the first ball 210 is in the up position, as discussed above, the first ball 210 is capable of effectively supporting a moving load, e.g., a tote moving across the platform 112, FIG. 1, of the conveyor system 100. As can be appreciated, when supporting a load in this manner, upward force on the first ball 210 is provided by air pressure within the chamber 290 of the second bearing 218 and the force applied by the second balls 219. It is noted that the force applied by the second balls 219 is derived from the air pressure within the cavities 298. The use of air pressure obviates the need for the first ball 210 to have mechanical contact with springs, roller bearings, etc. that otherwise would tend to create increased friction and, thus, heat and wear. Accordingly, the ball unit 200 is capable of conveying items in a high speed manner without appreciable wear or heat generation.

The air pressure supplied to each of the ball units 120, FIG. 1, on the platform 112 may be chosen and adjusted depending upon such factors as the weight of the individual items being conveyed. Other criteria for the air pressure supplied to the ball units 120 is the spacing of the ball units 120 within platform 112 such that adequate upward force is supplied to support the items above the surface 348 of the platform 112. It has been found, however, that even if the first ball 210 is forced to its down position, the supplied air pressure will still serve to reduce frictional contact between then first ball 210 and the second bearing 218 and, thus, continue to reduce frictional resistance to the moving load being conveyed.

It is noted that if the first ball 210 assumes an intermediate position between the up position and the down position, no seal will be established between the first ball 210 and the surface 282, FIG. 7. More specifically the first ball 210 is not in contact with the surface 282. Accordingly, in this condition, some compressed air will escape from the ball transfer unit 200. It has been found, however, that the amount of air escaping is relatively negligible so long as a small tolerance is maintained between the diameter of the cylindrical portion 294 of the second bearing 218, FIG. 8, and the diameter of the first ball 210 in a manner as previously described. It has further been found, that the relatively small amount of air that does tend to escape in this condition helps to cool the ball transfer unit 200 in a beneficial manner. Oil may be added to the compressed air so that the escaping air lubricates the ball units 120.

Although the use of compressed air has been disclosed herein, it is noted that other types of gases, such as nitrogen, could alternatively be used. Further, other types of fluids, (e.g., a liquid such as water) could also alternatively be used. As described above, the gas could have oil, which lubricates the ball transfer devices 120.

When the first ball 210 is in the down position, the first ball may contact the second ball 219. Thus, the second ball 219 may serve as a bearing for the first ball 210. In addition, the second ball 219 may roll within the cavity 298. The rolling will be improved if the friction between the second bearing 218 and the second ball 219 is minimized.

Other embodiments of the ball units include changing the size of the balls. For example, some heavier loads may be better transported using larger balls and lighter loads may be better transported using smaller balls. The bearings and other components withing the ball units may be changed to accommodate the different sized balls.

What is claimed is:

1. A ball transfer device comprising:
a chamber;
a first opening extending into said chamber;
a second opening extending into said chamber;
a cavity extending from said chamber, said cavity having a cavity opening connected to said second opening;
a first ball, wherein said first ball is movable within said chamber between a first position and a second position, wherein a portion of said first ball is
movable into said first opening when said first ball is in said first position, and wherein said first ball is located between said first opening and said second opening;
a second ball located in said cavity, wherein said second ball is movable within said cavity between a first position and a second position, wherein a portion of said second ball is movable into said chamber when said second ball is in said first position, and wherein said first ball is located between said cavity and said cavity opening;
wherein said second ball is contactable with said first ball when said second ball is in said first position.

2. The ball transfer device of claim 1, wherein said second opening is connectable to a fluid supply.

3. The ball transfer device of claim 2, wherein said fluid is air.

4. The ball transfer device of claim 1, wherein a positive fluid pressure is maintainable between said first ball and said second opening.

5. The ball transfer device of claim 1, wherein a positive fluid pressure is maintainable between said second ball and said cavity opening.

6. The ball transfer device of claim 1, wherein said first ball is movable into said first opening and wherein a greater portion of said first ball is located in said first opening when said first ball is in said first position than when said first ball is in said second position.

7. The ball transfer device of claim 1 and further comprising a first bearing located proximate said first opening, wherein said first ball is contactable with said first bearing.

8. The ball transfer device of claim 7, wherein said first bearing comprises oil impregnated wood.

9. The ball transfer device of claim 6, wherein said first bearing comprises a hole located adjacent said second opening and wherein said first ball is receivable in said hole.

10. The ball transfer device of claim 9, wherein said first bearing has a recessed portion connected to said hole, and wherein said recessed portion is configured to receive said first ball.

11. The ball transfer device of claim 1, and further comprising a second bearing located within said chamber, wherein said first ball is located between said first bearing and said second bearing.

12. The ball transfer device of claim 11, wherein said cavity is located in said second bearing.

13. The ball transfer device of claim 11, wherein said second bearing comprises wood.

14. The ball transfer device of claim 13, wherein said second bearing comprises oil impregnated wood.

15. The ball transfer device of claim 11, wherein said second bearing has a hole located therein and wherein said first ball is receivable in said hole when said first ball is in said second position.

16. The ball transfer device of claim 1 and further comprising material located proximate said first opening, wherein said material contacts said first ball when said first ball is in said first position and said second position.

17. The ball transfer device of claim 15, wherein said material has a hole located therein, said hole being adjacent said first opening and wherein said first ball is located within said hole.

18. A conveyor comprising:
a platform comprising at least one hole located therein;
a ball transfer device located in each of said at least one hole, said ball transfer device comprising:
a chamber;
a first opening extending into said chamber;
a second opening extending into said chamber;
a cavity extending from said chamber, said cavity having a cavity opening connected to said second opening;
a first ball, wherein said first ball is movable within said chamber between a first position and a second position, wherein a portion of said first ball is movable into said first opening when said first ball is in said first position, and wherein said first ball is located between said first opening and said second opening;
a second ball located in said cavity, wherein said second ball is movable within said cavity between a first position and a second position, wherein a portion of said second ball is movable into said chamber when said second ball is in said first position, and wherein said first ball is located between said cavity and said cavity opening;
wherein said second ball is contactable with said first ball when said second ball is in said first position.

19. The ball transfer device of claim 17, wherein said first ball is movable into said first opening and wherein a greater portion of said first ball is located in said first opening when said first ball is in said first position than when said first ball is in said second position.

20. The ball transfer device of claim 17 and further comprising a first bearing located proximate said first opening, wherein said first ball is contactable with said first bearing.
